(19) United States
(12) Patent Application Publication
(10) Pub. No.: US 2024/0416618 A1
(43) Pub. Date: Dec. 19, 2024

(54) SYSTEM AND METHOD TO OBFUSCATE THE PHYSICAL SECURITY ID (PSID) ON A DATA STORAGE DRIVE LABEL

(71) Applicant: Dell Products, L.P., Round Rock, TX (US)

(72) Inventors: Gordon A. Frye, Westborough, MA (US); Kenneth T. Coker, Firestone, CO (US); Daniel Duncan Rochat, Ogden, UT (US)

(73) Assignee: Dell Products, L.P., Round Rock, TX (US)

(21) Appl. No.: 18/335,280

(22) Filed: Jun. 15, 2023

(51) Int. Cl. B32B 7/08

(52) U.S. Cl. CPC B32B 7/08; B32B 2307/5825

(57) ABSTRACT

Systems and methods for obfuscating the physical security ID (PSID) on a data storage drive label are described. In an illustrative, non-limiting embodiment, an Information Handling System (IHS) may include: a device disposed within a chassis, where the device includes a label coupled thereto comprising: a numeric or alphanumeric portion; and a tamper evident portion that at least partially covers the numeric or alphanumeric portion. In another embodiment, a method includes obtaining an item associated with a data storage drive comprising a representation of a PSID of the data storage drive; and applying a tamper evident seal to the item to cover at least a portion of the representation of the PSID. In another embodiment, a data storage drive includes a first label, where the first label indicates a PSID associated with the data storage device; and a second tamper evident seal at least partially covering the PSID.

### FIELD

This disclosure relates generally to Information Handling Systems (IHSs), and more specifically, to systems and methods for obfuscating the Physical Security ID (PSID) on a data storage drive label.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use, such as financial transaction processing, airline reservations, enterprise data storage, or global communications. In addition, IHSs may include a variety of hardware and software components that may be configured to process, store, and communicate information and may include one or more computer systems, data storage systems, and networking systems.

One of the hardware components included in an IHS can be a data storage drive. Data storage drives can have labels. A data storage drive label can contain a serial number, which can be any numeric or alphanumeric sequence, and a Physical Security ID (PSID), which can also be a numeric or alphanumeric sequence.

The PSID can be a unique, static, 32-character key that is embedded in each drive at the factory. The PSIDs can also be printed on the drive's label, and can be retrieved by physically removing the drive from an IHS and reading its label. The PSID can be used in conjunction with the drive serial number to establish an authenticated authority over the device. The idea is that, as the PSID is printed on the case of the drive, someone needs to have physical access to the drive to unlock it, improving security. Therefore, in theory, only someone with physical possession of the drive can take ownership of the drive, because one would have to read the label.

### SUMMARY

Systems and methods for obfuscating the Physical Security ID (PSID) on a data storage drive label are described. In an illustrative, non-limiting embodiment, an Information Handling System (IHS) may include: a chassis; and a device disposed within the chassis, where the device includes a label coupled thereto, and where the label includes: a numeric or alphanumeric portion; and a tamper evident portion that at least partially covers the numeric or alphanumeric portion.

In some embodiments, the tamper evident portion includes a tamper-resistant label. In some embodiments, the tamper evident portion includes scratchable ink. In some embodiments, the tamper evident portion includes a scratchable label. In some embodiments, the device is selected from the group consisting of: a data storage drive, a network interface card, and a wireless network card.

In some embodiments, the numeric or alphanumeric portion of the label includes a PSID. In some of these embodiments, the PSID of the label includes an engraving on the device.

In another illustrative, non-limiting embodiment, a method includes: obtaining an item associated with a data storage drive comprising a numeric or alphanumeric representation of a PSID of the data storage drive; and applying a tamper evident seal to the item to cover at least a portion of the numeric or alphanumeric representation of the PSID.

In some embodiments, the method further includes: removing, at least partially, the tamper evident seal from the item to reveal the numeric or alphanumeric representation of a PSID. In some embodiments, the method further includes: sending the data storage drive comprising the item, where the tamper evident seal covers at least a portion of the numeric or alphanumeric representation of the PSID of the item, to an end user.

In some embodiments, the tamper evident seal includes a tamper-resistant label. In some embodiments, the tamper evident seal includes scratchable ink. In some embodiments, the tamper evident seal includes a scratchable label.

In some embodiments, the item associated with the data storage drive includes a label of the data storage drive. In some embodiments, the item associated with the data storage drive includes an engraving on the data storage drive.

In another illustrative, non-limiting embodiment, a data storage drive includes: a first label of the data storage drive, where the first label indicates a PSID associated with the data storage drive; and a second tamper evident seal at least partially covering the PSID indicated on the first label.

In some embodiments, the second tamper evident seal includes a tamper-resistant label. In some embodiments, the second tamper evident seal includes scratchable ink. In some embodiments, the second tamper evident seal includes a scratchable label. In some embodiments, the data storage drive includes a hard disk drive or a solid-state drive.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a diagram illustrating examples of hardware components of an Information Handling System (IHS), according to some embodiments.

FIG. 2 is a diagram of a data storage drive label with a unobfuscated Physical Security ID (PSID) (“Prior Art”).

FIG. 3 is a diagram of a data storage drive label illustrating a first example of a system and method for obfuscating the PSID on a data storage drive label, according to some embodiments.

FIG. 4 is a diagram of a data storage drive label illustrating a second example of a system and method for obfuscating the PSID on a data storage drive label, according to some embodiments.

FIG. 5 is a diagram of a data storage drive label illustrating a third example of a system and method for obfuscating the PSID on a data storage drive label, according to some embodiments.

### DETAILED DESCRIPTION

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price.

An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components.

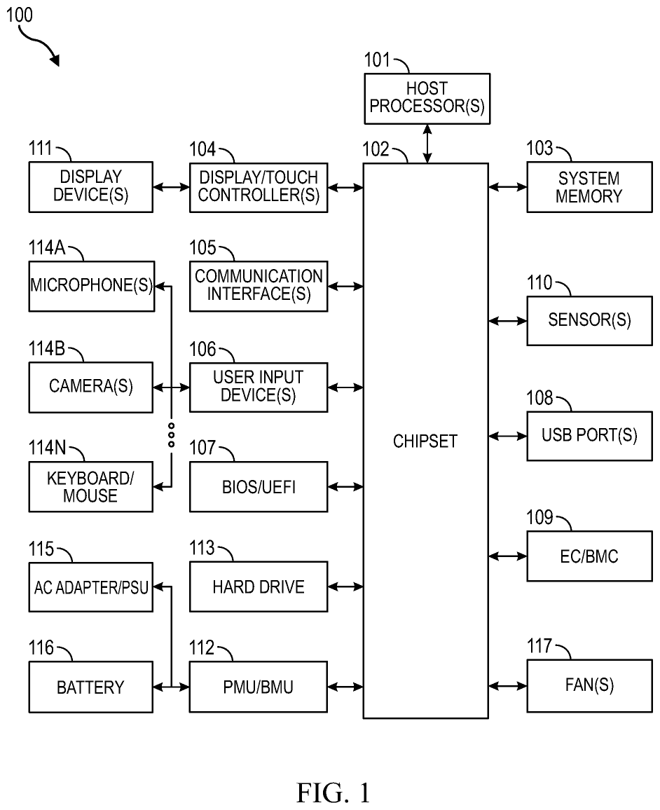

FIG. 1 is a block diagram of hardware components of IHS 100, which may be used to implement the systems and methods for obfuscating the Physical Security ID (PSID) on a data storage drive label (FIG. 1).

As depicted, IHS 100 includes host processor(s) 101. In various embodiments, IHS 100 may be a single-processor system, or a multi-processor system including two or more processors. Host processor(s) 101 may include any processor capable of executing program instructions, such as a PENTIUM processor, or any general-purpose or embedded processor implementing any of a variety of Instruction Set Architectures (ISAs), such as an x86 or a Reduced Instruction Set Computer (RISC) ISA (e.g., POWERPC, ARM, SPARC, MIPS, etc.).

IHS 100 includes chipset 102 coupled to host processor(s) 101. Chipset 102 may provide host processor(s) 101 with access to several resources. In some cases, chipset 102 may utilize a QuickPath Interconnect (QPI) bus to communicate with host processor(s) 101.

Chipset 102 may also be coupled to communication interface(s) 105 to enable communications between IHS 100 and various wired and/or wireless networks, such as Ethernet, WiFi, BLUETOOTH (BT), cellular or mobile networks (e.g., Code-Division Multiple Access or “CDMA,” Time-Division Multiple Access or “TDMA,” Long-Term Evolution or “LTE,” etc.), satellite networks, or the like. Communication interface(s) 105 may also be used to communicate with certain peripherals devices (e.g., BT speakers, microphones, headsets, etc.). Moreover, communication interface(s) 105 may be coupled to chipset 102 via a Peripheral Component Interconnect Express (PCIe) bus, or the like.

Chipset 102 may be coupled to display/touch controller(s) 104, which may include one or more Graphics Processor Units (GPUs) on a graphics bus, such as an Accelerated Graphics Port (AGP) or PCIe bus. As shown, display/touch controller(s) 104 provide video or display signals to one or more display device(s) 111.

Display device(s) 111 may include Liquid Crystal Display (LCD), Light Emitting Diode (LED), organic LED (OLED), or other thin film display technologies. Display device(s) 111 may include a plurality of pixels arranged in a matrix, configured to display visual information, such as text, two-dimensional images, video, three-dimensional images, etc. In some cases, display device(s) 111 may be provided as a single continuous display, or as two or more discrete displays.

Chipset 102 may provide host processor(s) 101 and/or display/touch controller(s) 104 with access to system memory 103. In various embodiments, system memory 103 may be implemented using any suitable memory technology, such as static RAM (SRAM), dynamic RAM (DRAM) or magnetic disks, or any nonvolatile/Flash-type memory, such as a solid-state drive (SSD) or the like.

Chipset 102 may also provide host processor(s) 101 with access to one or more Universal Serial Bus (USB) ports 108, to which one or more peripheral devices may be coupled (e.g., integrated or external webcams, microphones, speakers, etc.).

Chipset 102 may further provide host processor(s) 101 with access to one or more hard disk drives, solid-state drives, optical drives, or other removable-media drives 113.

Chipset 102 may also provide access to one or more user input devices 106, for example, using a super I/O controller or the like. Examples of user input devices 106 include, but are not limited to, microphone(s) 114A, camera(s) 114B, and keyboard/mouse 114N. Other user input devices 106 may include a touchpad, stylus or active pen, totem, etc.

Each of user input devices 106 may include a respective controller (e.g., a touchpad may have its own touchpad controller) that interfaces with chipset 102 through a wired or wireless connection (e.g., via communication interfaces(s) 105). In some cases, chipset 102 may also provide access to one or more user output devices (e.g., video projectors, paper printers, 3D printers, loudspeakers, audio headsets, Virtual/Augmented Reality (VR/AR) devices, etc.)

In certain embodiments, chipset 102 may further provide an interface for communications with hardware sensors 110.

Sensors 110 may be disposed on or within the chassis of IHS 100, or otherwise coupled to IHS 100, and may include, but are not limited to: electric, magnetic, radio, optical (e.g., camera, webcam, etc.), infrared, thermal (e.g., thermistors etc.), force, pressure, acoustic (e.g., microphone), ultrasonic, proximity, position, deformation, bending, direction, movement, velocity, rotation, gyroscope, Inertial Measurement Unit (IMU), and/or acceleration sensor(s).

Upon booting of IHS 100, host processor(s) 101 may utilize program instructions of Basic Input/Output System (BIOS) 107 to initialize and test hardware components coupled to IHS 100 and to load a host Operating System (OS) for use by IHS 100. BIOS 107 provides an abstraction layer that allows the host OS to interface with certain IHS components 100. Relying upon the hardware abstraction layer provided by BIOS 107, software stored in system memory 103 and executed by host processor(s) 101 can interface with certain I/O devices that are coupled to IHS 100.

The Unified Extensible Firmware Interface (UEFI) was designed as a successor to BIOS. As a result, many modern IHSs utilize UEFI in addition to or instead of a BIOS. As used herein, BIOS 107 is intended to also encompass a UEFI component.

Embedded Controller (EC) or Baseboard Management Controller (BMC) 109 is operational from the very start of each IHS power reset and handles various tasks not ordinarily handled by host processor(s) 101. Examples of these operations may include, but are not limited to: receiving and processing signals from a keyboard or touchpad, as well as other buttons and switches (e.g., power button, laptop lid switch, etc.), receiving and processing thermal measurements (e.g., performing fan control, CPU and GPU throttling, and emergency shutdown), controlling indicator LEDs (e.g., caps lock, scroll lock, num lock, battery, ac, power, wireless LAN, sleep, etc.), managing PMU/BMU 112, alternating current (AC) adapter/Power Supply Unit (PSU) 115 and/or battery 116, allowing remote diagnostics and remediation over network(s) 103, etc.

For example, EC/BMC 109 may implement operations for interfacing with power adapter/PSU 115 in managing power for IHS 100. Such operations may be performed to determine the power status of IHS 100, such as whether IHS 100 is operating from AC adapter/PSU 115 and/or battery 116.

Firmware instructions utilized by EC/BMC 109 may also be used to provide various core operations of IHS 100, such as power management and management of certain modes of IHS 100 (e.g., turbo modes, maximum operating clock frequencies of certain components, etc.).

In addition, EC/BMC 109 may implement operations for detecting certain changes to the physical configuration or posture of IHS 100. For instance, when IHS 100 as a 2-in-1 laptop/tablet form factor, EC/BMC 109 may receive inputs from a lid position or hinge angle sensor 110, and it may use those inputs to determine: whether the two sides of IHS 100 have been latched together to a closed position or a tablet position, the magnitude of a hinge or lid angle, etc. In response to these changes, the EC may enable or disable certain features of IHS 100 (e.g., front or rear facing camera, etc.).

In some cases, EC/BMC 109 may be configured to identify any number of IHS postures, including, but not limited to: laptop, stand, tablet, tent, or book. For example, when display(s) 111 of IHS 100 is open with respect to a horizontal keyboard portion, and the keyboard is facing up, EC/BMC 109 may determine IHS 100 to be in a laptop posture. When display(s) 111 of IHS 100 is open with respect to the horizontal keyboard portion, but the keyboard is facing down (e.g., its keys are against the top surface of a table), EC/BMC 109 may determine IHS 100 to be in a stand posture.

When the back of display(s) 111 is closed against the back of the keyboard portion, EC/BMC 109 may determine IHS 100 to be in a tablet posture. When IHS 100 has two display(s) 111 open side-by-side, EC/BMC 109 may determine IHS 100 to be in a book posture. When IHS 100 has two displays open to form a triangular structure sitting on a horizontal surface, such that a hinge between the displays is at the top vertex of the triangle, EC/BMC 109 may determine IHS 100 to be in a tent posture. In some implementations, EC/BMC 109 may also determine if display(s) 111 of IHS 100 are in a landscape or portrait orientation.

In some cases, EC/BMC 109 may be installed as a Trusted Execution Environment (TEE) component to the motherboard of IHS 100.

Additionally, or alternatively, EC/BMC 109 may be configured to calculate hashes or signatures that uniquely identify individual components of IHS 100. In such scenarios, EC/BMC 109 may calculate a hash value based on the configuration of a hardware and/or software component coupled to IHS 100. For instance, EC/BMC 109 may calculate a hash value based on all firmware and other code or settings stored in an onboard memory of a hardware component.

Hash values may be calculated as part of a trusted process of manufacturing IHS 100 and may be maintained in secure storage as a reference signature. EC/BMC 109 may later recalculate the hash value for a component may compare it against the reference hash value to determine if any modifications have been made to the component, thus indicating that the component has been compromised. In this manner, EC/BMC 109 may validate the integrity of hardware and software components installed in IHS 100.

In various embodiments, IHS 100 may be coupled to an external power source (e.g., AC outlet or mains) through AC adapter/PSU 115. AC adapter/PSU 115 may include an adapter portion having a central unit (e.g., a power brick, wall charger, or the like) configured to draw power from an AC outlet via a first electrical cord, convert the AC power to direct current (DC) power, and provide DC power to IHS 100 via a second electrical cord.

Additionally, or alternatively, AC adapter/PSU 115 may include an internal or external power supply portion (e.g., a switching power supply, etc.) connected to the second electrical cord and configured to convert AC to DC. AC adapter/PSU 115 may also supply a standby voltage, so that most of IHS 100 can be powered off after preparing for hibernation or shutdown, and powered back on by an event (e.g., remotely via wake-on-LAN, etc.). In general, AC adapter/PSU 115 may have any specific power rating, measured in volts or watts, and any suitable connectors.

IHS 100 may also include internal or external battery 116. Battery 116 may include, for example, a Lithium-ion or Li-ion rechargeable device capable of storing energy sufficient to power IHS 100 for an amount of time, depending upon the IHS's workloads, environmental conditions, etc. In some cases, a battery pack may also contain temperature sensors, voltage regulator circuits, voltage taps, and/or charge-state monitors.

Power Management Unit (PMU) 112 governs power functions of IHS 100, including AC adapter/PSU 115 and battery 116. For example, PMU 112 may be configured to: monitor power connections and battery charges, charge battery 116, control power to other components, devices, or ICs, shut down components when they are left idle, control sleep and power functions (“on” and “off”), manage interfaces for built-in keypad and touchpads, regulate real-time clocks (RTCs), etc.

In some implementations, PMU 112 may include one or more Power Management Integrated Circuits (PMICs) configured to control the flow and direction or electrical power in IHS 100. Particularly, a PMIC may be configured to perform battery management, power source selection, voltage regulation, voltage supervision, undervoltage protection, power sequencing, and/or charging operations. It may also include a DC-to-DC converter to allow dynamic voltage scaling, or the like.

Additionally, or alternatively, PMU 112 may include a Battery Management Unit (BMU) (referred to collectively as “PMU/BMU 112”). AC adapter/PSU 115 may be removably coupled to a battery charge controller within PMU/BMU 112 to provide IHS 100 with a source of DC power from battery cells within battery 116 (e.g., a lithium ion (Li-ion) or nickel metal hydride

(NiMH) battery pack including one or more rechargeable batteries). PMU/BMU 112 may include non-volatile memory and it may be configured to collect and store battery status, charging, and discharging information, and to provide that information to other IHS components.

Examples of information collected and stored in a memory within PMU/BMU 112 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information (e.g., such as ambient temperature, relative humidity, system geolocation measured by GPS or triangulation, time and date, etc.), and BMU events.

Examples of BMU events may include, but are not limited to: acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, power draw measurements may be conducted with control and monitoring of power supply via PMU/BMU 112. Power draw data may also be monitored with respect to individual components or devices of IHS 100. Whenever applicable, PMU/BMU 112 may administer the execution of a power policy, or the like.

IHS 100 may also include one or more fans 117 configured to cool down one or more components or devices of IHS 100 disposed inside a chassis, case, or housing. Fan(s) 117 may include any fan inside, or attached to, IHS 100 and used for active cooling. Fan(s) 117 may be used to draw cooler air into the case from the outside, expel warm air from inside, and/or move air across a heat sink to cool a particular IHS component. In various embodiments, both axial and sometimes centrifugal (blower/squirrel-cage) fans may be used.

In other embodiments, IHS 100 may not include all the components shown in FIG. 1. In other embodiments, IHS 100 may include other components in addition to those that are shown in FIG. 1. Furthermore, some components that are represented as separate components in FIG. 1 may instead be integrated with other components, such that all or a portion of the operations executed by the illustrated components may instead be executed by the integrated component.

For example, in various embodiments described herein, host processor(s) 101 and/or other components of IHS 100 (e.g., chipset 102, display/touch controller(s) 104, communication interface(s) 105. EC/BMC 109, etc.) may be replaced by discrete devices within a heterogenous computing platform (e.g., a System-On-Chip or “SoC”). As such, IHS 100 may assume different form factors including, but not limited to: servers, workstations, desktops, laptops, appliances, video game consoles, tablets, smartphones, etc.

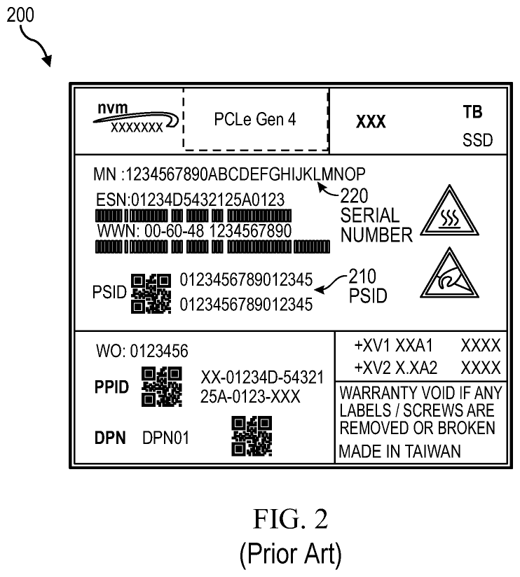

FIG. 2 is a diagram of a data storage drive label 200 with unobfuscated PSID 210 (“Prior Art”). The data storage drive label 200 contains at least a serial number 220, which can be any numeric or alphanumeric sequence, and a PSID, which can also be a numeric or alphanumeric sequence.

The PSID can be a unique, static, 32-character key that is embedded in each drive at the factory, in some embodiments. PSIDs can also be printed on the drive's label, and can be retrieved only by physically removing the drive from an IHS and reading its label, in some embodiments. The PSID can be used in conjunction with the drive serial number to establish an authenticated authority over the device. The idea is that, as the PSID is printed on the case of the drive, someone needs to have physical access to the drive to unlock it, improving security. Therefore, in theory, only someone with physical possession of the drive can take ownership of the drive, because one would have to read the label.

In some embodiments, PSID-locked drives cannot be accessed in certain ways or configured without the PSID. TCG Opal is the software commonly used on disk drives that uses the PSID. In order to take possession of the device and secure the device through the application (e.g., TCG Opal application) a user needs to supply the PSID identification.

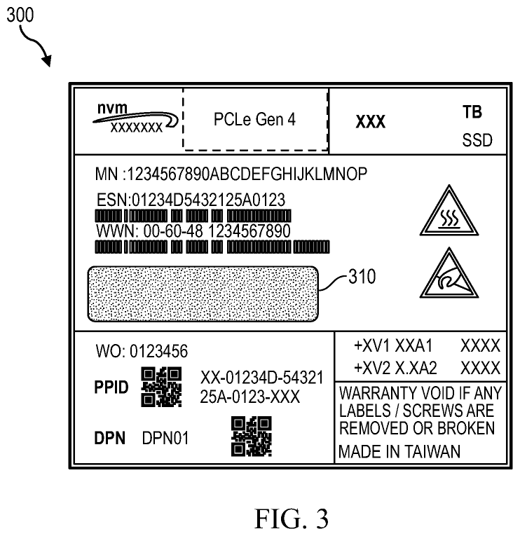

FIG. 3 is a diagram of a data storage drive label 300 illustrating a first example of a system and method for obfuscating the PSID 310 on a data storage drive label, according to some embodiments. The label 300 can be a piece of paper, fabric, plastic, or similar material attached to the data storage drive and giving information about it, or can be an engraving on the data storage drive, in some embodiments. In some embodiments, the label 300 can be item, such as a piece of paper, fabric, plastic, or similar material, associated with a data storage drive, but not necessarily attached to the data storage drive. In some embodiments, component 300 may be instantiated, at least in part, on data storage drives such as hard disk drives, solid-state drives, optical drives, and/or other removable-media drives 113 of an IHS 100.

PSIDs can be an important component for self-encrypting drives (SEDs). SEDs are hard drives or solid-state drives that transparently encrypt all on-disk data using an internal key and a drive access password. SEDs can use an encryption key to secure the data stored on the disk. This encryption can protect a drive from data theft, for example, when a drive is removed from an IHS or array. If an SED drive's internal key or drive access password is lost, the drive data will be permanently inaccessible and the drive must be reset and reformatted in order to be repurposed, in some embodiments.

In an array environment. SEDs can operate across all disks in an array at once. If one drive in a RAID set is removed from the array, a new set of encryption key shares can be generated automatically and shared among the remaining disks. If a second drive is removed from the same RAID set, another set of encryption key shares can be generated. SED drives can be configured at the factory. When the drives are installed into an array, the array can automatically detect the new SED drives and lock them. This process can be automatic, in some embodiments.

SED drives can be initially in a factory-fresh state, known as the unowned state, in some embodiments. In this state, no encryption keys exist on the drive or the IHS, and encryption is not enabled. A first initialization step can be to generate a randomized internal drive encryption key (“DEK”) by using the drive's embedded encryption hardware, in some embodiments. This key can be used by the drive hardware to encrypt all incoming data before writing it to disk, and to decrypt any disk data being read by an IHS, in some of these embodiments.

A second step can be to generate a drive control key or drive access password, otherwise known as an access key (“AK”), in some embodiments. This password can be used each time the drive is accessed by the IHS. Without the password, the drive is completely inaccessible. Once encryption has been set up, the SED drive is in a secure, owned state and is ready to be formatted, in some embodiments.

A SED drive can be cryptographically erased and reset to a factory-fresh state in two ways. A first way is by performing a process that resets the DEK, and deletes the AK, thereby cryptographically erasing the drive. In some embodiments, such process may involve the use of a release command. In other embodiments, such process may involve the use of a “smartfail” command.

A second way to cryptographically erase an SED drive and reset to a factory-fresh state is to use a process that requires the PSID. This can be called a revert command, in some embodiments. A drive can be manually reverted to the unowned state by using its PSID. In some embodiments, after the PSID is entered, at the manual revert prompt for example, then all of the drive data is deleted and the SED drive is returned to an unowned state.

The release command requires the drive password to run, whereas the revert command requires the drive PSID. If the drive password is still known and functional, the IHS can release the drive after a smartfail process completes, or during an IHS reimage, without requiring manual intervention. If the drive password is lost or no longer functional, the revert command must be used instead, and the PSID must be entered manually.

Smartfail can cryptographically erase a functional SED drive. During the smartfail process, the DEK is reset and the AK is deleted, cryptographically erasing the drive. In a successful smartfail condition, changing the DEK cryptographically erases data, and deleting the AK blocks read/write access to existing data.

After the smartfail process completes, the IHS deletes the drive access password from the keystore and the drive deletes its internal encryption key. As a result, the data is inaccessible and is considered cryptographically erased, and the drive is reset to the unowned state. The drive can then be reused after a new encryption key is generated, or the drive can be provided to a third party, without any risk of the third party accessing the data.

If the SED drive is mishandled, such as interrupting the formatting process or removing the drive from a powered-on IHS, the IHS can delete its drive access password from the keystore database where the drive access passwords are stored. If the internal drive key or the drive access password or both are lost or deleted, all of the data on the drive becomes permanently inaccessible and unreadable. This process is seen as cryptographic erasure, as the data still exists, but cannot be decrypted. The drive can be subsequently unusable, unless it can be manually reverted to the unowned state.

If a drive is removed from a running IHS, the drive's operating system can assume that the drive has failed, and can initiate the smartfail process, in some embodiments. If the drive is reinserted before the smartfail process completes, a user can run certain commands, such as add and stopfail commands, to bring the drive back online and return it to a healthy state, in some embodiments. However, if the smartfail process has completed before a user reinserts the drive, and the user runs a stopfail command, the drive access password for the removed drive is deleted from the IHS's keystore, in some embodiments. If this occurs, the data on the drive can no longer be accessed and is considered cryptographically erased, in these embodiments.

If a drive is reinserted and/or added back to an IHS after it has been released, it will be displayed as being in the SED_ERROR state because the drive still contains encrypted data but the drive access password no longer exists in the IHS's keystore. If the drive has failed to release properly, then the drive is, at this point, inaccessible and unusable, and all the data on the drive is inaccessible—with even a release command or a smartfail command being inoperable. However, there is one thing a user can do at this point. A user can still revert the drive to an unowned state by using its PSID. The user, of course, would need to have physical access to the drive and be able to manually read the PSID off of the drive's label. After the user reverts the drive using the PSID, then the user can reuse the drive.

Therefore, SEDs are about protecting data at rest, in some embodiments. SED drives cannot be taken out of a system, put into another system, and have the cleartext taken off of the drives. An SED prevents the migration of data from one system to another system using the SED drives, without having the passwords.

To erase all SED drives in a single IHS that is being removed from a cluster, the IHS can be smartfailed from the cluster, in some embodiments. In these embodiments, all drives will be automatically released and cryptographically erased by the IHS when the smartfail process completes. To erase all SED drives in an entire cluster, or in a single IHS configured as a cluster of one, or in an unconfigured IHS, a user can either reimage or reformat the IHS, in some embodiments. Both processes can release the drives and then delete the IHS keystore, in these embodiments. In these embodiments, any drives that fail to release properly will still be cryptographically erased because their drive access passwords are deleted with the rest of the keystore during the process. Any SED drives in IHSs that will be redeployed elsewhere, and that are currently in an unreleased state, must be manually reverted by using their PSID before they can be used again.

However, if the PSID is not obfuscated, then the PSID and serial number are visible during manufacturing, transport, and handling prior to the end-user taking ownership of the device. Exposure of the PSID on the drive label could lead to potential misuse due to the ability to record and use the un-protected PSID value. Someone could have the ability to record the PSID and serial number and potentially use that information for nefarious activities. That person could be a worker in the transport process, for example. Anybody along the transit path who has had access to the drive can record the PSID (and also the serial number) and then use the PSID later for nefarious purposes. Such a nefarious actor could take ownership of the device, since they would potentially have both the serial number and the PSID.

For example, a worker in a manufacturing facility might be installing drives into a system. Such a worker might be performing final assembly and test of a product. The worker might also have access to an order sheet that specifies the destination of the system. For example, the order sheet might say that the system is to be shipped to a certain department of the federal government. If the PSIDs were not obfuscated, and if the worker were a bad actor, then the worker could take pictures of all the PSIDs of all the drives in the system. The worker could then share or sell that information to other bad actors to create an attack vector on that system. The bad actor(s) could potentially know the installation site of the system, as it might be on the customer order. If the bad actor(s) also know the PSID, because the PSID was not obfuscated, then the bad actor could perform nefarious activities.

One type of nefarious activity that a bad actor with a PSID of a drive could perform is the reversion and reformatting of the drive, where the all the data on the drive is thereby lost. The bad actor could maliciously destroy a legitimate end user's data. The bad actor might demand a ransom so that they would not maliciously destroy other data on other drives, for example.

Another type nefarious activity that a bad actor with a PSID of a drive could perform is establishing false credentials on the drive. A bad actor could establish false credentials, such as their own passwords, using the PSID. Establishing their own credentials allows a bad actor access to a drive, and for an SED drive, erodes the protection of data at rest. A bad actor could set up a user or an administrator role, and then leave the drive as is for the end user.

Another type nefarious activity that a bad actor with a PSID of a drive could perform is counterfeiting access to an SED drive. Access to the PSID can allow a bad actor, for example, to revert the drive into a state that would allow the bad actor to substitute their own firmware (e.g., counterfeit firmware) for the drive's firmware. The bad actor could in essence transform the drive into a counterfeit drive that looks like an SED. The malicious firmware could then allow a legitimate end user to create their own credentials for accessing the drive, as is normally done with an SED. However, the malicious firmware would allow the bad actor to have access to all the data that the legitimate end-user writes to the drive, because the legitimate end-user credentials are only established with the malicious firmware.

Knowledge of the PSID can allow a bad actor to put a drive, such as an SED drive, into a factory-fresh state, or an unowned state. Once a drive is in such a state, then the bad actor can do whatever they want to the drive, in some embodiments. In one scenario, the bad actor could destroy the data on the drive. In another scenario, the bad actor could have full visibility of the drive and control.

Therefore, obfuscation of the PSID can be achieved by covering the PSID with a physical method, such as a tamper evident seal, to protect the PSID from misuse, according to some embodiments. Tamper-evident seals are security seals that provide tamper evidence when broken, tampered with, removed and/or accessed, in some embodiments. Sometimes also known as indicative seals, tamper-evident seals can usually be broken, tampered with, removed and/or accessed by hand or with a light tool, so they're intended to deter tampering, but usually do not prevent anyone from accessing the property or information being protected. Tamper-evident seals might be applied by the drive manufacturer, in some embodiments. In other embodiments, the tamper-evident seals might be applied by an IHS manufacturer before or after the drive has been installed into the IHS.

In some embodiments, tamper-evident seals might be applied by a robotic arm, or by machinery (such as assembly line machinery) that apply the tamper-evident seals to cover the PSID portion of a label attached to the data storage drive. For example, such a manufacturing machine may identify a data storage device disposed on a conveyor belt, at least in part, by using an image capture device and applying an image recognition and/or feature extraction technique to acquired images. In some cases, the data storage device may already be installed within an IHS chassis, and the entire IHS chassis may move down the assembly line. As such, the manufacturing machine may be configured to identify the location (e.g., by X-Y-Z coordinates) and orientation of an IHS chassis, of a data storage device within the chassis, of a label attached to the data storage device, and/or of a PSID portion of the label (i.e., the portion to receive the tamper-evident seal).

The same or a different manufacturing machine may then apply the tamper-evident seal to the PSID portion of a label attached to the data storage device (e.g., to the exclusion of any other portions or areas of the label).

By using tamper-evident seals, the PSID associated with a data storage drive can be protected during manufacturing, handling, and/or transportation until it reaches the end-user's hands. The tamper-evident seal is configured to prevent malicious access to the data storage drive and/or tampering of the data storage drive. Tamper-evident seals can protect the integrity of the PSID, such that someone who has had temporary access to the drive cannot launch an attack with the PSID. Obfuscation of the PSID narrows the attack surface of the drive. Anyone that has access to the drive during the manufacturing, transport, and/or handling prior to the end-user taking ownership of the device, does not have access to the PSID, in these embodiments.

At the time the end-user takes ownership, the PSID obfuscation can be removed to provide the end-user with access to the PSID, so that the end-user can take ownership of the drive and secure operations of the drive.

If the end-user discovers that the tamper-evident seal shows signs of tampering, then the end-user can take one or more corrective and/or responsive actions. The end-user can contact either the drive manufacturer, the IHS manufacturer, or the IHS seller and report that the tamper-evident seal indicates that the drive has been tampered with. In such a scenario, the drive manufacturer, the IHS manufacturer, or the IHS seller might send a replacement drive or a replacement IHS, ask that the drive or IHS be returned, or ask that the drive or IHS be provided for servicing. The user could then return the data storage drive and/or the IHS, or provide the data storage drive and/or IHS for servicing. During servicing, the data storage drive with the broken tamper-evident seal may be replaced with a new data storage drive, where the tamper-evident seal covers the PSID, without any evidence of tampering. The user might take additional and/or other corrective actions, other than the ones specified here, and these types of corrective actions specified should not be construed as limiting.

Returning to FIG. 3, the PSID can be protected with a tamper-resistant label 310, according to some embodiments. A tamper-resistant label 310 is a type of tamper evident seal, in some embodiments. Tamper-resistant labels 310 can leave irreversible, visible evidence when the label has been tampered with. Tamper-resistant labels 310 can show signs when someone has tried to open or tamper with a device. The tamper-resistant label 310 can be removed by the end user to reveal the PSID, in some embodiments. If the tamper-resistant label 310 shows evidence of tampering, then the end user can take the one or more corrective actions specified above, in some embodiments.

In some embodiments, these tamper-resistant labels contain features that can make it impossible to remove or peel up the material without damaging it in an obvious way. Tamper-resistant labels might not separate easily from the item they are attached to, in some embodiments. In addition, tamper-resistant labels can be designed to split or separate after any attempt to remove them, in some embodiments. Multiple tamper-resistant label options are available including, fracturing labels and labels that leave a footprint when removed. In some embodiments, tamper-resistant labels tear easily. Once the label is torn or removed, the damage can be obvious, in some embodiments. This helps users identify if the label has been tampered with. It also prevents genuine product labels from being transferred to counterfeit products, for example.

In some embodiments, tamper-resistant labels might implement one or more of the following three design strategies to change their appearance when they're damaged. First, tamper-resistant labels might have hidden print layers, in some embodiments. These types of tamper-resistant labels can have multiple printed layers. The bottom layer can use a strong adhesive, and the top layer uses a weak adhesive. When the label is torn, only the top layer is removed, revealing the print underneath. Typical printing includes statements like “VOID,” “OPENED” or “TAMPER EVIDENT” can printed multiple times across the inner label, in some embodiments. Contrasting colors can be used to draw attention to the damaged label, in some embodiments.

Second, tamper-resistant labels might have security cuts and perforations, in some embodiments. Die cuts and perforations used on the label keep them from being removed in one piece. The peeled-up sections left behind are easy for users to notice and prevent labels from being removed and placed on other products.

Third, tamper-resistant labels might have detailed printing, in some embodiments. While it may be easy to realign most labels after opening a container, it can be difficult if there's fine printing around the area. The misalignment of text, graphics, and barcodes helps draw the user's eye to the tear so that they know the PSID was accessed.

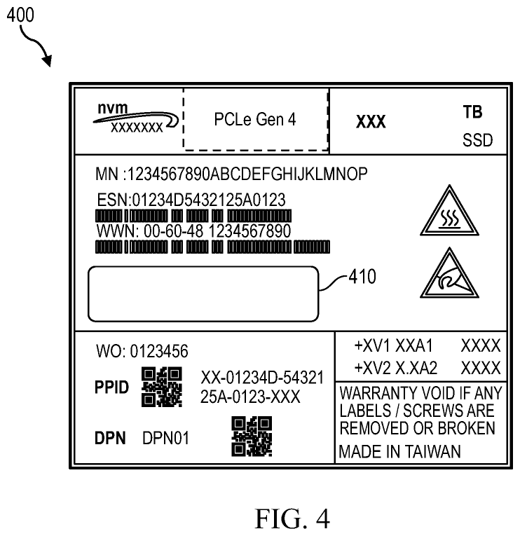

FIG. 4 is a diagram of a data storage drive label 400 illustrating a second example of a system and method for obfuscating the PSID on a data storage drive label 400, according to some embodiments. The label 400 can be a piece of paper, fabric, plastic, or similar material attached to the data storage drive and giving information about it, or can be an engraving on the data storage drive, in some embodiments. In some embodiments, the label 400 can be item, such as a piece of paper, fabric, plastic, or similar material, associated with a data storage drive, but not necessarily attached to the data storage drive. In some embodiments, component 400 may be instantiated, at least in part, on data storage drives such as hard disk drives, solid-state drives, optical drives, and/or other removable-media drives 113 of an IHS 100.

FIG. 4 depicts the PSID being obfuscated with scratchable ink 410. Scratchable ink 410 is a type of tamper evident seal, in some embodiments. Scratchable ink can be a special rubberized ink coating that can be applied using screen printing techniques, in some embodiments. This ink can obscure a message underneath, and can be removed by scratching with a fingernail, coin or some other object. The ink can be sufficiently opaque to dependably conceal information underneath, in some embodiments. The ink can be readily removable so that the user can read the information, in some embodiments. If the scratchable ink 410 shows evidence of tampering, then the end user can take the one or more corrective actions specified above, in some embodiments.

First, the information to be concealed can be printed, usually lithographically or digitally, in some embodiments. Then a special release coating can be screen printed over the information to be concealed, in some embodiments. The release coating, such as for example a clear varnish or pigmented varnish ink, can be applied to the form before the scratch-off coating is applied, and preferably over the indicia to be hidden. The release coating can allow the user to remove the opaque cover coating by scratching the form with a fingernail, coin or the like. The release coating can protect the message from overzealous scratching, and can also give a consistent surface for the scratch-off ink to adhere, in some embodiments.

Then the scratchable ink can be applied on top of that, and if necessary, an overprint coating for additional protection or as a design feature. The scratchable ink coating can be a mixture of resin, rubber, solvent and pigment, in some embodiments. When the coating is applied the solvent can evaporate quickly, with the pigment remaining, in some of these embodiments. The scratchable ink 410 can be removed by the end user to reveal the PSID, in some embodiments. If the scratchable ink 410 shows evidence of tampering, then the end user can take the one or more corrective actions specified above, in some embodiments.

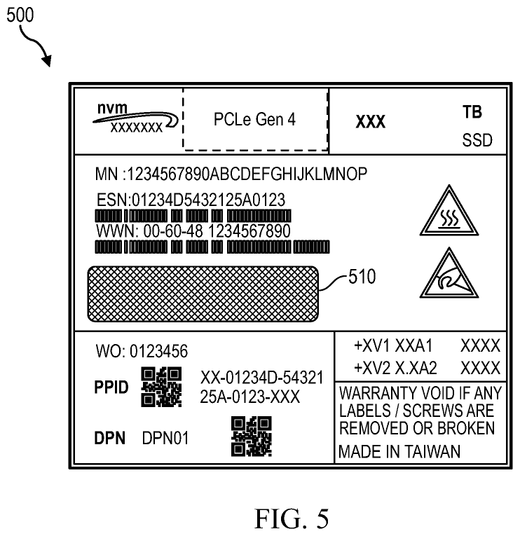

FIG. 5 is a diagram of a data storage drive label 500 illustrating a third example of a system and method for obfuscating the PSID on a data storage drive label 500, according to some embodiments. The label 500 can be a piece of paper, fabric, plastic, or similar material attached to the data storage drive and giving information about it, or can be an engraving on the data storage drive, in some embodiments. In some embodiments, the label 500 can be item, such as a piece of paper, fabric, plastic, or similar material, associated with a data storage drive, but not necessarily attached to the data storage drive. In some embodiments, component 500 may be instantiated, at least in part, on data storage drives such as hard disk drives, solid-state drives, optical drives, and/or other removable-media drives 113 of an IHS 100.

FIG. 5 depicts the PSID being obfuscated with a scratchable label 510. A scratchable label 510 is a type of tamper evident seal, in some embodiments. Scratchable labels 510 can be clear stickers with scratch off pigment on top, in some embodiments. An applier can peel the scratchable label, and place them on existing text or print, in some embodiments. The scratch off pigment of the scratchable label 510 can then be at least partially removed by the end user to reveal the PSID underneath the clear part of the label, in some embodiments. In some embodiments, the clear portion of the label remains on the existing text or print after the scratch off pigment on top of the clear label has been removed or partially removed. If the scratchable label 510 shows evidence of tampering, then the end user can take the one or more corrective actions specified above, in some embodiments.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks.

Program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. Operational data may be collected as a single data set or may be distributed over different locations including over different storage devices.

Reference is made herein to “configuring” a device or a device “configured to” perform some operation(s). This may include selecting predefined logic blocks and logically associating them. It may also include programming computer software-based logic of a retrofit control device, wiring discrete hardware components, or a combination of thereof. Such configured devices are physically designed to perform the specified operation(s).

Various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. An Information Handling System (IHS), comprising:
a chassis; and
a device disposed within the chassis, wherein the device comprises a label coupled thereto, and wherein the label comprises:
a numeric or alphanumeric portion; and
a tamper evident portion that at least partially covers the numeric or alphanumeric portion.

2. The IHS of claim 1, wherein the tamper evident portion comprises a tamper-resistant label.

3. The IHS of claim 1, wherein the tamper evident portion comprises scratchable ink.

4. The IHS of claim 1, wherein the tamper evident portion comprises a scratchable label.

5. The IHS of claim 1, wherein the device is selected from the group consisting of: a data storage drive, a network interface card, and a wireless network card.

6. The IHS of claim 1, wherein the numeric or alphanumeric portion of the label comprises a Physical Security ID (PSID).

7. The IHS of claim 6, wherein the PSID of the label comprises an engraving on the device.

8. A method, comprising:
obtaining an item associated with a data storage drive comprising a numeric or alphanumeric representation of a Physical Security ID (PSID) of the data storage drive; and
applying a tamper evident seal to the item to cover at least a portion of the numeric or alphanumeric representation of the PSID.

9. The method of claim 8, further comprising:
removing, at least partially, the tamper evident seal from the item to reveal the numeric or alphanumeric representation of a PSID.

10. The method of claim 8, further comprising:
sending the data storage drive comprising the item, wherein the tamper evident seal covers at least a portion of the numeric or alphanumeric representation of the PSID of the item, to an end user.

11. The method of claim 8, wherein the tamper evident seal comprises a tamper-resistant label.

12. The method of claim 8, wherein the tamper evident seal comprises scratchable ink.

13. The method of claim 8, wherein the tamper evident seal comprises a scratchable label.

14. The method of claim 8, wherein the item associated with the data storage drive comprises a label of the data storage drive.

15. The method of claim 8, wherein the item associated with the data storage drive comprises an engraving on the data storage drive.

16. A data storage drive, comprising:
a first label of the data storage drive, wherein the first label indicates a Physical Security ID (PSID) associated with the data storage drive; and
a second tamper evident seal at least partially covering the PSID indicated on the first label.

17. The data storage drive of claim 16, wherein the second tamper evident seal comprises a tamper-resistant label.

18. The data storage drive of claim 16, wherein the second tamper evident seal comprises scratchable ink.

19. The data storage drive of claim 16, wherein the second tamper evident seal comprises a scratchable label.

20. The data storage drive of claim 16, wherein the data storage drive comprises a hard disk drive or a solid-state drive.
